(19) United States
(12) Patent Application Publication
(10) Pub. No.: US 2008/0125098 A1
(43) Pub. Date: May 29, 2008

(54) System and method of providing call information

(75) Inventors: Les D. Bruce, Chicago, IL (US); Jeffrey L. Brandt, Cedar Park, TX (US); Marc A. Sullivan, Austin, TX (US); Mark B. Hubscher, San Antonio, TX (US)

Correspondence Address: TOLER LAW GROUP, 8500 BLUFFSTONE COVE, SUITE A201, AUSTIN, TX, 78759, US

(73) Assignee: SBC Knowledge Ventures, LP, Reno, NV (US)

(21) Appl. No.: 11/592,709

(22) Filed: Nov. 3, 2006

(51) Int. Cl. H04N 7/173; H04N 5/445; H04M 3/42

(52) U.S. Cl. 455/414.1; 725/106; 725/32; 348/569; 725/110; 455/415; 348/E05.002; 725/62

(57) ABSTRACT

A method for providing call information is disclosed and includes receiving information related to a call at a set-top box device, the call received at a wireless phone. The method also includes sending the information related to the call to a display device coupled to the set-top box device when the wireless phone is within a pre-defined region.

### FIELD OF THE DISCLOSURE

The present disclosure relates generally to providing call information.

### BACKGROUND

Television viewing is part of daily life for many people. Individuals may prefer to monitor call information related to calls at a wireless phone, while watching television. When a wireless phone user is not watching television, for example, other television viewers may not wish to view the call information related to calls at the wireless phone. Hence, there is a need for an improved system and method of providing call information.

### BRIEF DESCRIPTION OF THE DRAWINGS

FIG. 1 is a block diagram illustrating a particular illustrative embodiment of a system to provide call information;

FIG. 2 is a block diagram illustrating a second particular illustrative embodiment of a system to provide call information;

FIG. 3 is a flow diagram depicting a particular illustrative embodiment of a method of providing call information;

FIG. 4 is a flow diagram depicting a second particular illustrative embodiment of a method of providing call information;

FIG. 5 is a flow diagram depicting a third particular illustrative embodiment of a method of providing call information;

FIG. 6 is a diagram illustrating a particular illustrative embodiment of a graphical user interface to provide call information;

FIG. 7 is a diagram illustrating a second particular illustrative embodiment of a graphical user interface to provide call information;

FIG. 8 is a diagram illustrating a third particular illustrative embodiment of a graphical user interface to provide call information; and

FIG. 9 is a diagram of an illustrative embodiment of a general computer system.

### DETAILED DESCRIPTION OF THE DRAWINGS

A set-top box device is disclosed and includes a processor and a memory device accessible to the processor. The memory device includes instructions to receive information related to a call received at a wireless phone and to send the information to a display device coupled to the set-top box device when the wireless phone is within a pre-defined region that includes a position of the set-top box device.

In another embodiment, a method to provide call information is disclosed and includes receiving information related to a call at a set-top box device, the call received at a wireless phone. The method also includes sending the information related to the call to a display device coupled to the set-top box device when the wireless phone is within a pre-defined region.

In another embodiment, a method of providing call information, is disclosed and includes receiving, at a server of an Internet Protocol Television (IPTV) system, position information related to a wireless phone. The method also includes determining whether the wireless phone is within a pre-defined region.

In another embodiment, a computer-readable medium is disclosed, tangibly embodying instructions to manipulate a computing platform to receive information related to a call at a set-top box device, the call received at a wireless phone. The computer-readable medium also includes instructions to send the information to a display device coupled to the set-top box device when the wireless phone is within a pre-defined region.

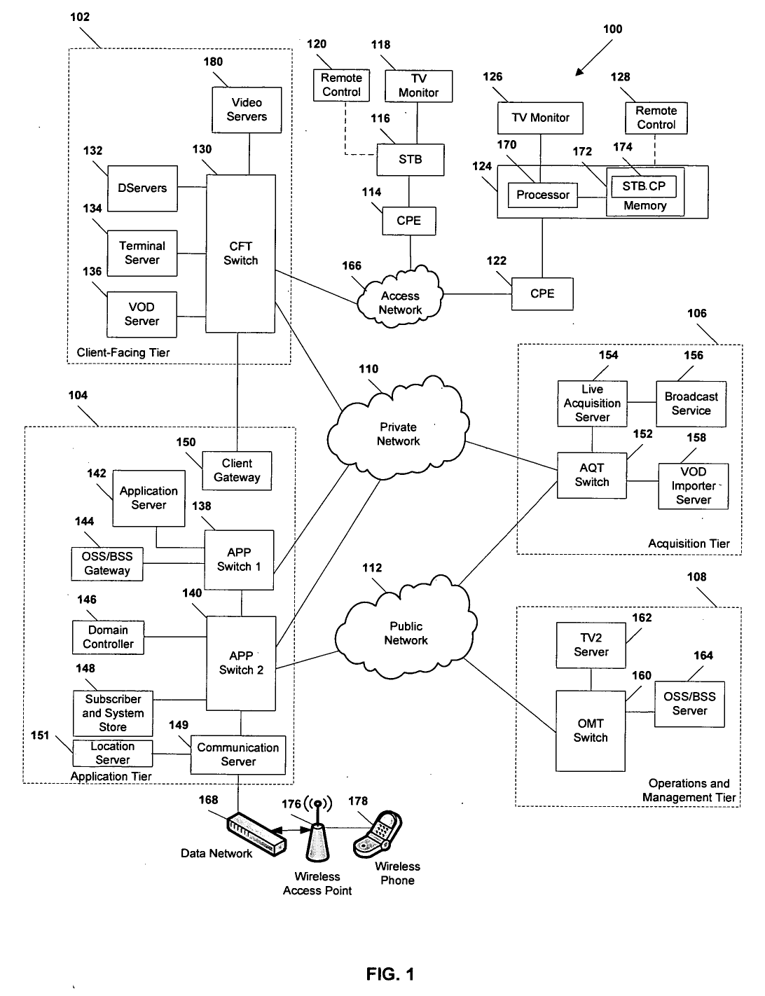

Referring to FIG. 1, an illustrative embodiment of an Internet Protocol Television (IPTV) system that may be used to provide call information is illustrated and generally designated at 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

The client-facing tier 102 can communicate with user equipment via an access network 166, such as an Internet Protocol Television (IPTV) access network. In an illustrative embodiment, customer premises equipment (CPE) 114, 122 can be coupled to a local switch, router, or other device of the access network 166. The client-facing tier 102 can communicate with a first representative set-top box device 116 via the first CPE 114 and with a second representative set-top box device 124 via the second CPE 122. In a particular embodiment, the first representative set-top box device 116 and the first CPE 114 can be located at a first customer premise, and the second representative set-top box device 124 and the second CPE 122 can be located at a second customer premise. In another particular embodiment, the first representative set-top box device 116 and the second representative set-top box device 124 can be located at a single customer premise, both coupled to one of the CPE 114, 122.

The CPE 114, 122 can include routers, local area network devices, modems, such as digital subscriber line (DSL) modems, any other suitable devices for facilitating communication between a set-top box device, the access network 166, or any combination thereof. In an exemplary embodiment, the client-facing tier 102 can be coupled to the CPE 114, 122 via fiber optic cables. In another exemplary embodiment, the CPE 114, 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the access network 166, via an IPTV software platform, such as Microsoft® TV IPTV Edition.

The first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device 124 can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 116, 124 can receive data, video, or any combination thereof, from the client-facing tier 102 via the access network 166 and render or display the data, video, or any combination thereof, at the display device 118, 126 to which it is coupled. In an illustrative embodiment, the set-top box devices 116, 124 can include tuners that receive and decode television programming signals or packet streams for transmission to the display devices 118, 126. Further, the set-top box devices 116, 124 can include a STB processor 170 and a STB memory device 172 that is accessible to the STB processor 170. In one embodiment, a computer program, such as the STB computer program 174, can be embedded within the STB memory device 172.

In an illustrative embodiment, the client-facing tier 102 can include a client-facing tier (CFT) switch 130 that manages communication between the client-facing tier 102 and the access network 166 and between the client-facing tier 102 and the private network 110. As illustrated, the CFT switch 130 is coupled to one or more data servers, such as D-servers 132, that store, format, encode, replicate, or otherwise manipulate or prepare video content for communication from the client-facing tier 102 to the set-top box devices 116, 124. The CFT switch 130 can also be coupled to a terminal server 134 that provides terminal devices with a connection point to the private network 110. In a particular embodiment, the CFT switch 130 can be coupled to a video-on-demand (VOD) server 136 that stores or provides VOD content imported by the IPTV system 100. Further, the CFT switch 130 is coupled to one or more video servers 180 that send the video content to the set-top box devices 116, 124 via the access network 166. In a particular embodiment, the CFT switch 130 can be coupled to a video-on-demand (VOD) server 136 that stores or provides VOD content imported by the IPTV system 100. Further, the CFT switch 130 is coupled to one or more multicast video servers 180 that receive video content and multicast the video content to the set-top box devices 116, 124 via the access network 166.

In an illustrative embodiment, the client-facing tier 102 can communicate with a large number of set-top box devices via the access network 166, such as the representative set-top box devices 116, 124, over a wide geographic area, such as a neighborhood area, a metropolitan area, a viewing area, a statewide area, a regional area, a nationwide area or any other suitable geographic area, market area, or subscriber or customer group that can be supported by networking the client-facing tier 102 to numerous set-top box devices. In a particular embodiment, the CFT switch 130, or any portion thereof, can include a multicast router or switch that communicates with multiple set-top box devices via a multicast-enabled network.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an operation systems and support (OSS)/billing systems and support (BSS) gateway 144. In a particular embodiment, the application server 142 can provide applications to the set-top box devices 116, 124 via the access network 166, which enable the set-top box devices 116, 124 to provide functions, such as interactive program guides, video gaming, display, messaging, processing of VOD material and other IPTV content, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server. 164 that stores operations and billing systems data.

The second APP switch 140 can be coupled to a domain controller 146 that provides Internet access, for example, to users at their computers via the public network 112. For example, the domain controller 146 can provide remote Internet access to IPTV account information, e-mail, personalized Internet services, or other online services via the public network 112. In addition, the second APP switch 140 can be coupled to a subscriber and system store 148 that includes account information, such as account information that is associated with users who access the IPTV system 100 via the private network 110 or the public network 112. In an illustrative embodiment, the subscriber and system store 148 can store subscriber or customer data and create subscriber or customer profiles that are associated with IP addresses, stock-keeping unit (SKU) numbers, other identifiers, or any combination thereof, of corresponding set-top box devices 116, 124. Further, the second APP switch 140 can be coupled to a communication server 149 that communicates with a wireless phone 178 via a data network 168 and a wireless access point 176. A location server 151 can store data defining a pre-defined region that may include, e.g., the set-top box device 124. The location server 151 can be coupled to the communication server 149. The communication server 149 can transmit the data defining the pre-defined region to the location server 151, and receive the data defining the pre-defined region from the location server 151.

In a particular embodiment, the application tier 104 can include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto. In an illustrative embodiment, the set-top box devices 116, 124, or other devices coupled to the CPE 114, 122, can access the IPTV system 100 via the access network 166, using information received from the client gateway 150. User devices can access the client gateway 150 via the access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the access network 166.

For example, when the first representative set-top box device 116 accesses the client-facing tier 102 via the access network 166, the client gateway 150 can verify subscriber information by communicating with the subscriber and system store 148 via the private network 110. Further, the client gateway 150 can verify billing information and status by communicating with the OSS/BSS gateway 144 via the private network 110. In one embodiment, the OSS/BSS gateway 144 can transmit a query via the public network 112 to the OSS/BSS server 164. After the client gateway 150 confirms subscriber and/or billing information, the client gateway 150 can allow the set-top box device 116 to access IPTV content and VOD content at the client-facing tier 102. If the client gateway 150 cannot verify subscriber information for the set-top box device 116, e.g., because it is connected to an unauthorized twisted pair, the client gateway 150 can block transmissions to and from the set-top box device 116 beyond the access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television content, movie content, advertisement content, other video content, or any combination thereof, from a broadcast service 156, such as a satellite acquisition system or satellite head-end office. In a particular embodiment, the live acquisition server 154 can transmit content to the AQT switch 152, and the AQT switch 152 can transmit the content to the CFT switch 130 via the private network 110.

In an illustrative embodiment, content can be transmitted to the D-servers 132, where it can be encoded, formatted, stored, replicated, or otherwise manipulated and prepared for communication from the video server(s) 180 to the set-top box devices 116, 124. The CFT switch 130 can receive content from the video server(s) 180 and communicate the content to the CPE 114, 122 via the access network 166. The set-top box devices 116, 124 can receive the content via the CPE 114, 122, and can transmit the content to the television monitors 118, 126. In an illustrative embodiment, video or audio portions of the content can be streamed to the set-top box devices 116, 124.

Further, the AQT switch 152 can be coupled to a video-on-demand importer server 158 that receives and stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices. 116, 124, the requests can be transmitted over the access network 166 to the VOD server 136, via the CFT switch 130. Upon receiving such requests, the VOD server 136 can retrieve the requested VOD content and transmit the content to the set-top box devices 116, 124 across the access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 186 that monitors network devices within or coupled to the IPTV system 100. In a particular embodiment, the OMT switch 160 can communicate with the AQT switch 152 via the public network 112.

In an illustrative embodiment, the live acquisition server 154 can transmit content to the AQT switch 152, and the AQT switch 152, in turn, can transmit the content to the OMT switch 160 via the public network 112. In this embodiment, the OMT switch 160 can transmit the content to the TV2 server 162 for display to users accessing the user interface at the TV2 server 162.

In a particular embodiment, the set-top box device 124 can receive information related to a call received at the wireless phone 178. The information related to the call can be sent to the set-top box device 124 from the communication server 149, which can receive the information related to the call from the wireless access point 176 via the data network 168. The communication server 149 can also receive information related to a position of the wireless phone 178. The communication server 149 can also receive information defining a pre-defined region, and can store the information at a location server 151. In a particular illustrative embodiment, the information defining the pre-defined region may be supplied from sources that may include, but are not limited to, the wireless access point 176 via the data network 168, a set of Global Positioning System (GPS) coordinates, a spatial extent of a WiFi network, or a combination of these sources. The communication server 149 can retrieve the information defining the pre-defined region from the location server 151, subscriber and system store 148, or other server at the Internet Protocol Television system 100, and can determine whether the wireless phone 178 is within the pre-defined region by comparing the position of the wireless phone 178 to the information defining the pre-defined region. In a non-limiting illustrative embodiment, the pre-defined region may be a sphere centered about the set-top box device 124.

In a particular embodiment, the communication server 149 can receive information related to a call received at the wireless phone 178 from the wireless access point 176 via the data network 168, information from the location server 151 defining the pre-defined region, and position information of the wireless phone 178 from, e.g., the wireless access point 176 via the data network 168, or from a WiFi system in communication with the wireless phone 178, or from Global Positioning System coordinates, or from radio contact with the wireless phone 178, or any combination thereof. The communication server 149 can determine whether the wireless phone 178 is within the pre-defined region by comparing the position of the wireless phone 178 to the information defining the pre-defined region. The communication server 149 or other server of the IPTV system 100 can transmit a location indicator to the set-top box device 124, indicating whether the wireless phone 178 is within the pre-defined region. When the location indicator indicates that the wireless phone 178 is within the pre-defined region, the set-top box device 124 can send the information related to the call to a display device coupled to the set-top box device 124, such as the television monitor 126, where the information related to the call can be displayed.

In a particular embodiment, the communication server 149 can receive information related to a call received at the wireless phone 178 from the wireless access point 176 via the data network 168. The communication server 149 can also receive position information for the wireless phone 178 from the wireless access point 176 via the data network 168. The communication server 149 can also receive information related to a pre-defined region, storing the information at a location server 151. The communication server 149 can evaluate whether the wireless phone 178 is within the pre-defined region. When the wireless phone 178 is within the pre-defined region, the communication server 149 can transmit the information related to the call to the set-top box device 124. The set-top box device 124 can send the information related to the call to a display device coupled to the set-top box device, such as the television monitor 126, where the information related to the call can be displayed.

In an illustrative embodiment, several set-top box devices may be located within a single premise. A wireless phone user or other set-top box device user may have the capability of choosing which set-top boxes can receive the information related to the call.

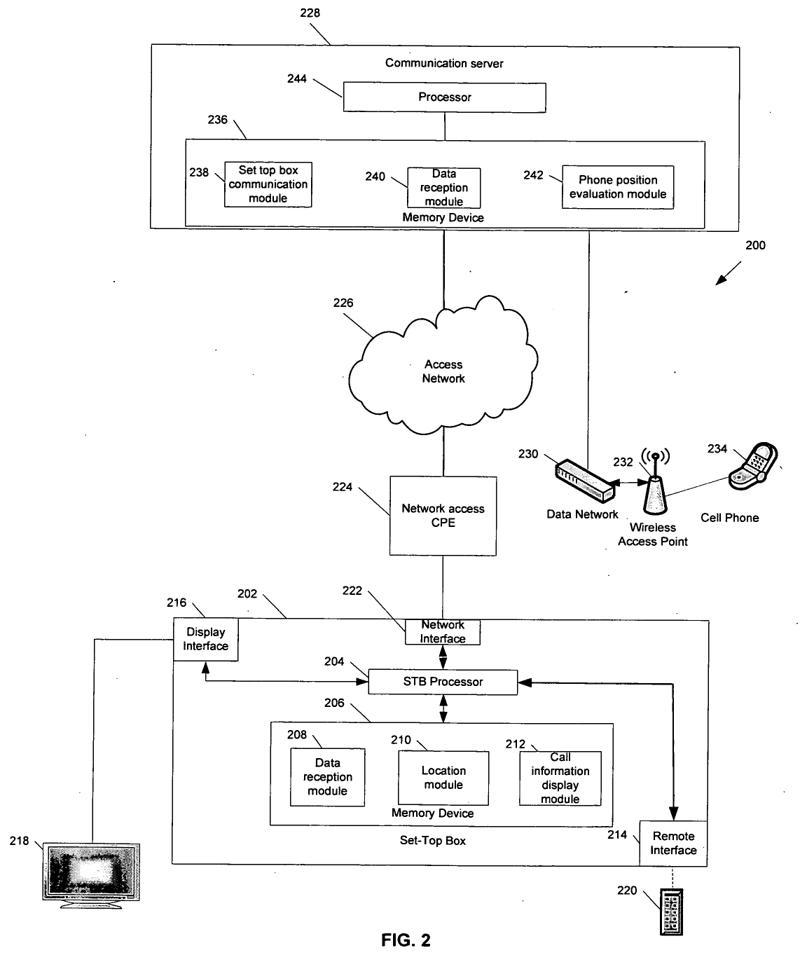

Referring to FIG. 2, a second particular illustrative embodiment of a system to provide call information is illustrated and designated generally at 200. The system 200 includes a set-top box device 202 that can communicate with a communication server 228 via an access network 226, such as a private access network of an Internet Protocol Television (IPTV) system. The communication server 228 can receive information related to a call received at a wireless phone from a wireless access point via a data network. The communication server 228 can also receive position information for the wireless phone from the wireless access point via the data network. The communication server 228 can also receive information related to a pre-defined region, storing the information related to the pre-defined region at a location server, and retrieving the information from the location server when needed to determine whether the wireless phone is within the pre-defined region.

In an illustrative embodiment, the set-top box device 202 can be coupled to network access Consumer Premises Equipment (CPE) 224. In an illustrative embodiment, the STB processor 204 can communicate with the communication server 228 via a network interface 222. In a particular embodiment, network access CPE 224 can facilitate communication, via access network 226, between the network interface 222 and the communication server 228. The network access CPE 224 can include a router, a local area network device, a modem, such as a digital subscriber line (DSL) modem, and any other suitable device or any combination thereof to facilitate communication between the network interface 222 of the set-top box device 202 and the communication server 228.

The set-top box device 202 includes a processor 204 and a memory device 206 accessible to the processor 204. The processor 204 is operative to communicate with the network interface 222, and with a display interface 216, each of which is coupled with the processor 204. In a particular embodiment the set-top box device 202 may also include a remote interface 214, operative to receive commands from a remote device 220.

In a particular embodiment, the memory device 206 can include a data reception module 208 executable by the processor 204 to receive call information related to a call received at a wireless phone. Call information can include, for example, caller name, caller phone number, caller address, date of call, time of call, city of origin at time of the call, or any combination thereof. In an illustrative embodiment, the call information related to the call may include caller identification (caller I.D.) information.

In a particular embodiment, the memory device 206 can include a location module 210 executable by the processor 204 to determine whether the wireless phone is within a pre-defined region, e.g., by receiving a location indicator from the communication server 228 indicating that the wireless phone is, or is not, within the pre-defined region.

In a particular embodiment, the memory device 206 can include a call information display module 212 executable by the processor 204 to send the call information related to the call to a display device coupled to the set-top box device 202 when the wireless phone is within the pre-defined region. In a particular illustrative embodiment, the display device may be a television monitor 218 coupled to the set-top box device 202 via a display interface 216.

The communication server 228 includes a communication server processor 244 and a memory device 236 accessible to the communication server processor 244. In a particular embodiment, the memory device 236 can include a set-top box communication module 238 executable by the communication server processor 244 to communicate with the set-top box device 202 to send call information related to a call, a location indicator, or any combination thereof, to the set-top box device 202.

In a particular embodiment, the memory device 236 can include a data reception module 240 executable by the communication server processor 244 to receive call information related to a call; to receive information related to a position of the wireless phone 234; and to receive data defining a pre-defined region and store the data defining the pre-determined region at, e.g., another server such as a location server. In an illustrative embodiment, the call information related to the call and the position information for the wireless phone 234 can be received by the communication server 228 from the wireless access point 232 via the data network 230.

In a particular embodiment, the memory device 236 can include a phone position evaluation module 242 executable by the communication server processor 244 to determine whether the wireless phone 234 is within a pre-defined region, and to generate the location indicator indicating whether the wireless phone 234 is within the pre-defined region.

In another illustrative embodiment, the phone position evaluation module 242 is executable by the communication server processor 244 to determine whether the wireless phone 234 is within a pre-defined region. The set-top box communication module 236 can be executable by the communication server processor 244 to send call information to the set-top box device 202 when the wireless phone 234 is within the pre-defined region, and to not send the call information related to the call to the set-top box device 202 when the when the wireless phone 234 is not within the pre-defined region.

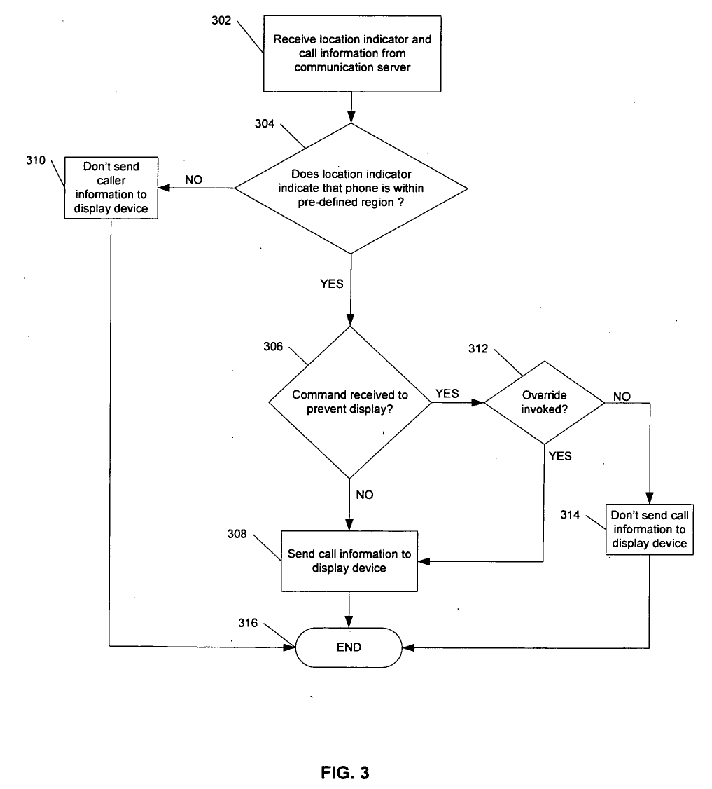

Referring to FIG. 3, a particular illustrative embodiment of a method of providing call information is illustrated. At block 302, a location indicator and call information related to a call received by a wireless phone are received at a set-top box device from a server. In an illustrative embodiment, the server can be a communication server or other server of an IPTV system. Advancing to decision node 304, the set-top box device evaluates the location indicator. If the location indicator indicates that the wireless phone is not within a pre-defined region, the method moves to block 310 and the set-top box device does not send call information pertaining to the call to a display device.

Returning to decision node 304, if the location indicator indicates that the wireless phone is within the pre-defined region, the method proceeds to decision node 306, and the set-top box device evaluates whether a command has been received to prevent display of the call information related to the call. If a command to prevent display of the call information has not been received, the method proceeds to block 308, and the call information is sent to a display device coupled to the set-top box device. In an illustrative embodiment, the display device is a television monitor. Conversely, if a command is received by the set-top box device to prevent display, the method advances to decision node 312, and the set-top box device determines whether an override has been invoked. If an override has been invoked, the method proceeds to block 308. On the other hand, if an override has not been invoked, the method proceeds to block 314, and the set-top box device does not send the call information to the display device. The method terminates at 316.

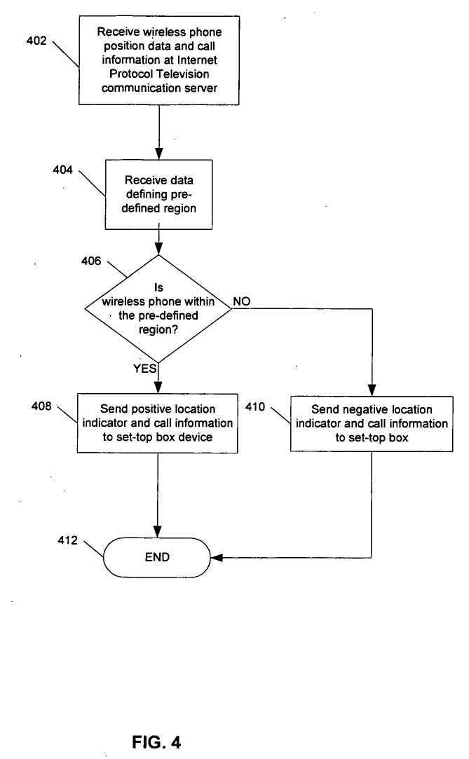

Referring to FIG. 4, a second particular illustrative embodiment of a method of providing call information is illustrated. At block 402, a communication server of an Internet Protocol Television (IPTV) system receives wireless phone position data and call information related to a call received at a wireless phone. In an illustrative embodiment, the communication server may receive the wireless phone position data and the call information from a wireless network. Moving to block 404, the communication server receives data defining a pre-defined region. In an illustrative non-limiting embodiment, the data defining the pre-defined region may be the spatial extent of a WiFi network. In another illustrative non-limiting embodiment, the data defining the pre-defined region may be Global Positioning System (GPS) coordinates. In another illustrative non-limiting embodiment, the data defining the pre-defined region may be a plurality of property boundary lines.

Proceeding to decision node 406, the communication server determines whether the wireless phone is within the pre-defined region. In a particular embodiment, a wireless phone that is at or on a boundary of the pre-defined region can be determined to be within the pre-defined region. If the wireless phone is not within the pre-defined region, the method proceeds to block 410, and the communication server sends a location indicator indicating that the wireless phone is not within the pre-defined region. In a particular embodiment, the communication server can also send the call information related to the call received at the wireless phone to the set-top box device. Returning to decision node 406, if the wireless phone is within the pre-defined region, the method advances to block 408, and the communication server sends a location indicator indicating that the wireless phone is within the pre-defined region. In a particular embodiment, the communication server can also send the call information related to the call received at the wireless phone to the set-top box device. The method terminates at 412.

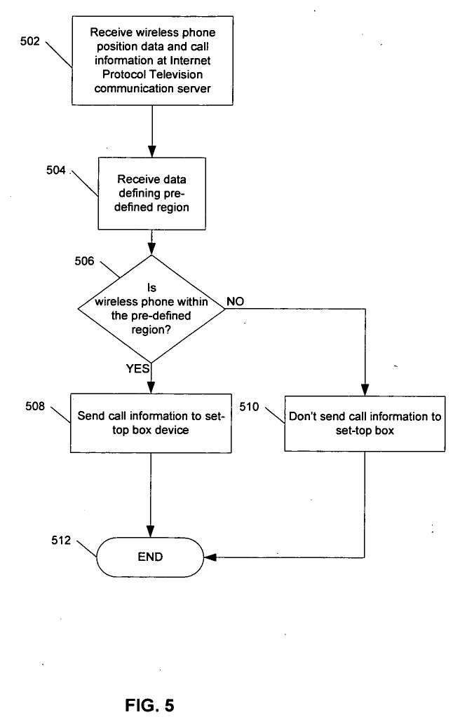

Referring to FIG. 5, a third particular illustrative embodiment of a method of providing call information is illustrated. At block 502, a communication server of an Internet Protocol Television (IPTV) system receives wireless phone position data and call information related to a call received at a wireless phone. In an illustrative embodiment, the communication server may receive the wireless phone position data and the call information from a wireless network. Moving to block 504, the communication server receives data defining a pre-defined region about a set-top box device, such as a set-top box device associated with a user of the wireless phone. In an illustrative non-limiting embodiment, the data defining the pre-defined region may be the spatial extent of a WiFi network. In another illustrative non-limiting embodiment, the data defining the pre-defined region may be Global Positioning System (GPS) coordinates. In another illustrative non-limiting embodiment, the data defining the pre-defined region may be a plurality of property boundary lines.

Proceeding to decision node 506, the communication server determines whether the wireless phone is within the pre-defined region. If the wireless phone is not within the pre-defined region, the method proceeds to block 510, and the communication server does not send call information related to the call to the set-top box device. Conversely, if the wireless phone is within the pre-defined region, the method advances to block 508, and the communication server sends the call information to the set-top box device. The method terminates at 512.

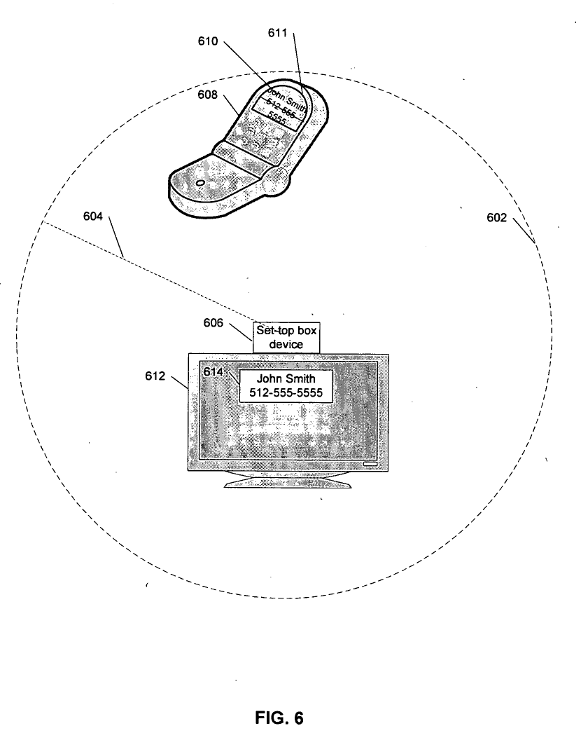

Referring to FIG. 6, a diagram illustrating a third particular illustrative embodiment of a system to provide call information is illustrated. A sphere 602 with a radius 604, the sphere 602 centered about a set-top box device 606, can define a pre-defined region 602. Call information 610 related to a call received at a wireless phone 608 can be displayed at a screen 611 of the wireless phone 608. The wireless phone 608 is within the pre-defined region 602. The set-top box device 606 can receive the call information 610, and send it to a display device 612, where it can be displayed at region 614.

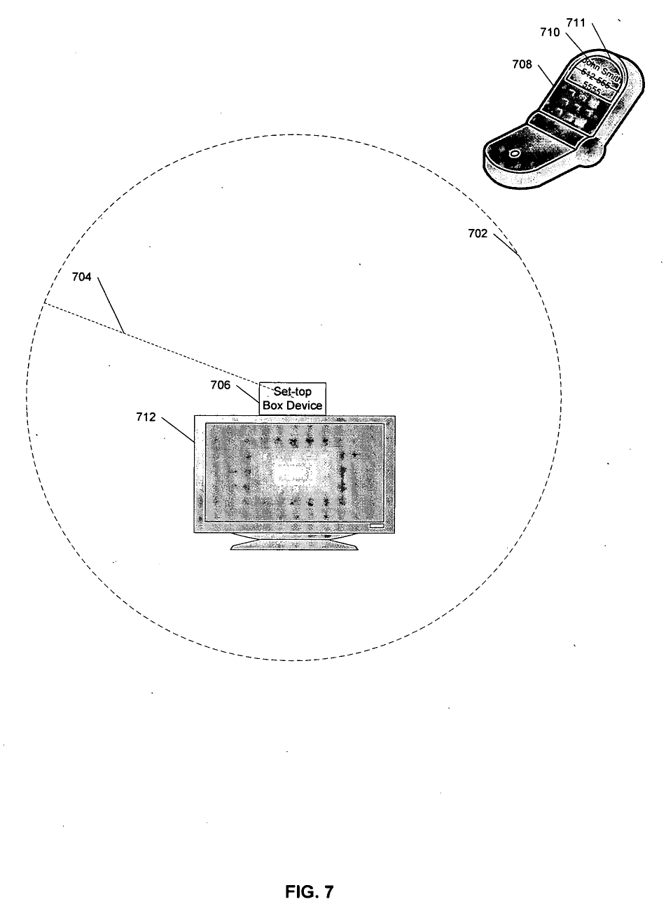

Referring to FIG. 7, a diagram illustrating a fourth particular illustrative embodiment of a system to provide call information is illustrated. A sphere 702 with a radius 704, the sphere 702 centered about a set-top box 706, can define a pre-defined region 702. Call information 710 related to a call received at a wireless phone 708 can be displayed at a screen 711 of the wireless phone 708. The wireless phone 708 is not within the pre-defined region 702. The set-top box device 706 will not send the call information to a display device 712.

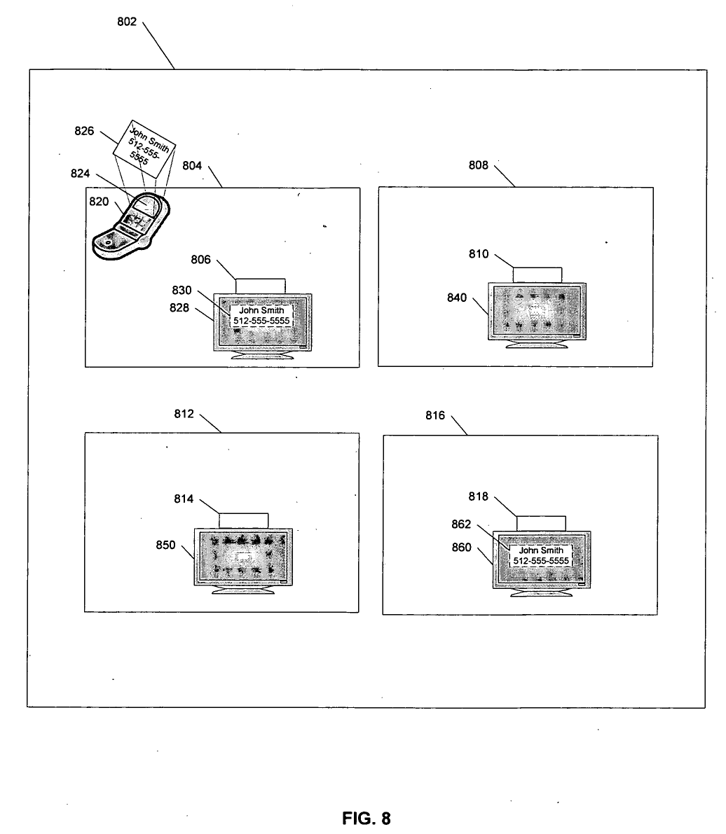

Referring to FIG. 8, a diagram illustrating a fifth particular illustrative embodiment of a system to provide call information is illustrated. A rectangle 802 is a two-dimensional representation of a boundary of a premise, in which set-top box devices 806, 810, 814, and 818 are located within respective rooms 804, 808, 812, 816, wherein each of the rectangles is two-dimensional representation of a three dimensional room. The room 804 can define a pre-defined region. A wireless phone 820 is within the pre-defined region. In an illustrative embodiment, a screen 824 can display call information 826 related to a call at the wireless phone 820. The call information 826 can be received at the set-top box device 806, which can transmit the call information 826 to a display device 828, and can be displayed at a region 830.

The rooms 808, 812, and 816 can define other respective pre-defined regions. In an illustrative embodiment, the wireless phone 806 is not within the pre-defined regions defined by rooms 808, 812, respectively. The call information 826 is not displayed at display devices 840, and 850, which are coupled to respective set-top box devices 810 and 814.

In an illustrative embodiment, the wireless phone 820 is within the pre-defined region 804. The call information 826 can be received at a set-top box device 818, which is in the room 816. The set-top box device 818 is situated outside of the pre-defined region defined by room 804. The set-top box device 818 can transmit the call information 826 to a display device 860, and can be displayed at a region 862.

In conjunction with the configuration of structure described herein, the system and method disclosed provides call information related to a call received by a wireless phone at a display device coupled to a set-top box device when the wireless phone is within a pre-defined region. In a particular embodiment, a set-top box device can receive information related to a call received at the wireless phone. In an illustrative embodiment, the information related to the call can be sent to the set-top box device by a communication server or other server. The communication server can also receive position information related to the wireless phone. The communication server can also receive data defining a pre-defined region and can store the data defining the pre-defined region at, e.g., a location server, for retrieval when needed. The communication server can determine whether the wireless phone is within the pre-defined region by comparing the information related to the position of the wireless phone with the data defining the pre-defined region. The communication server can transmit a location indicator to the set-top box device, indicating whether the wireless phone is within the pre-defined region. When the location indicator indicates that the wireless phone is within the pre-defined region, the set-top box device can send the information related to the call to a display device coupled to the set-top box device.

In another illustrative embodiment, a communication server can receive information related to a call received at a wireless phone. The communication server can also receive information related to a position of the wireless phone. The communication server can also receive data defining a pre-defined region and can store the data defining the pre-defined region at, e.g., a location server, for retrieval when needed. The communication server can determine whether the wireless phone is within the pre-defined region by comparing the information related to the position of the wireless phone with the data defining the pre-defined region. In an illustrative embodiment, when the wireless phone is within the pre-defined region, the communication server can transmit the information related to the call to the set-top box device, and the set-top box device can send the information related to the call to a display device coupled to the set-top box device.

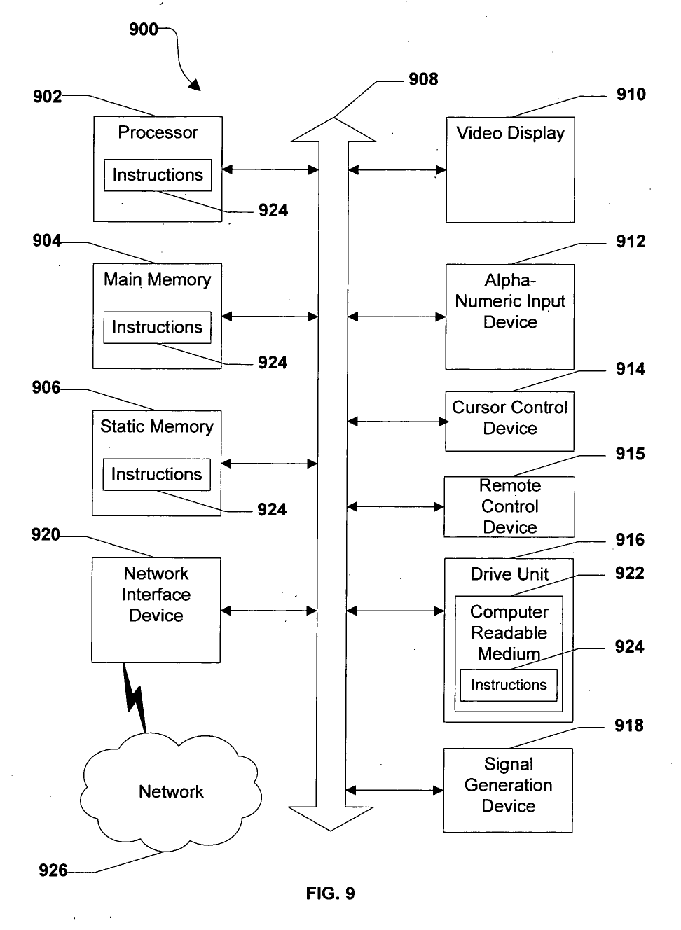

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900, or any portion thereof, may operate as a stand-alone device or may be connected, e.g., using a public network, such as the Internet, or a private network, to other computer systems or peripheral devices such as a set-top box device, communication server, or a phone, as depicted in FIGS. 1-2.

In a networked deployment, the computer system may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box device (STB), a personal digital assistant (PDA), a mobile device, a palmtop computer, a laptop computer, a desktop computer, a communications device, a wireless phone, a land-line phone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. Further, the computer system 900 can include a wireless input device 915, e.g., a remote control device. When the computer system 900, or any portion thereof, is embodied in a set-top box device, the cursor control device 914 can be a remote control device. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing call information, the method comprising:
receiving information related to a call at a set-top box device, the call received at a wireless phone; and
sending the information related to the call to a display device coupled to the set-top box device when the wireless phone is within a pre-defined region.

2. The method of claim 1, wherein the information related to the call includes caller identification information.

3. The method of claim 1, further comprising receiving the information related to the call from an Internet Protocol Television (IPTV) system.

4. The method of claim 3, further comprising receiving a location indicator at the set-top box device from the Internet Protocol Television system, the location indicator indicating whether the wireless phone is within the pre-defined region.

5. The method of claim 1, further comprising not sending the identification information to the display device when the wireless phone is not within the pre-defined region.

6. The method of claim 1, further comprising:
receiving, at the set-top box device, a command to not send the information to the display device; and
not sending the information to the display device unless an override function has been enabled at the set-top box device.

7. A method of providing call information, the method comprising:
receiving, at a server of an Internet Protocol Television (IPTV) system, position information related to a wireless phone; and
determining if the wireless phone is within a pre-defined region.

8. The method of claim 7, wherein the set-top box device is associated with a user of the wireless phone.

9. The method of claim 7, further comprising receiving the position information from a wireless network associated with the wireless phone.

10. The method of claim 7, further comprising receiving, from a wireless network, information related to a call received at the wireless phone.

11. The method of claim 10, further comprising sending the information related to the call to the set-top box device when the wireless phone is within the pre-defined region.

12. The method of claim 10, further comprising not sending the information related to the call to the set-top box device when the wireless phone is not within the pre-defined region.

13. The method of claim 10, further comprising:
sending a location indicator to the set-top box device, indicating whether the wireless phone is within the pre-defined region; and
sending the information related to the call to the set-top box device, wherein the set-top box device sends the information related to the call to a display device when the wireless phone is within the pre-defined region.

14. The method of claim 10, wherein the set-top box device is one of a plurality of set-top box devices associated with the wireless phone.

15. The method of claim 14 further comprising receiving a selection of the set-top box device at the server.

16. A set-top box device, comprising:
a processor and a memory device accessible to the processor, wherein the memory device includes instructions to:
receive information related to a call received at a wireless phone; and
send the information to a display device coupled to the set-top box device when the wireless phone is within a pre-defined region that includes a position of the set-top box device.

17. The set-top box device of claim 16, wherein the pre-defined region is defined by a three dimensional extent of a home Wireless Fidelity (WiFi) network.

18. The set-top box device of claim 16, wherein the pre-defined region is defined by a three dimensional region specified by Global Positioning System (GPS) coordinates.

19. The set-top box device of claim 16, wherein the pre-defined region is defined by a plurality of property boundary lines.

20. The set-top box device of claim 16, wherein the memory device further includes instructions to communicate with a communication server of an Internet Protocol Television system to receive a location indicator, the location indicator indicating whether the wireless phone is within the pre-defined region.

21. A computer-readable medium tangibly embodying instructions to manipulate a computing platform to:
receive information related to a call at a set-top box device, the call received at a wireless phone; and
send the information to a display device coupled to the set-top box device when the wireless phone is within a pre-defined region.

22. The computer-readable medium of claim 21, further comprising instructions to manipulate a computing platform to not send the information to the display device when the wireless phone is not within the pre-defined region.
